(19) United States
(12) Patent Application Publication
(10) Pub. No.: US 2026/0060159 A1
(43) Pub. Date: Mar. 5, 2026

(54) DISC BLADE WITH V-NOTCH AND ASSOCIATED SYSTEMS AND METHODS

(71) Applicant: Osmundson Mfg. Co., Perry, IA (US)

(72) Inventor: Heather Bruce, Perry, IA (US)

(21) Appl. No.: 19/313,128

(22) Filed: Aug. 28, 2025

Related U.S. Application Data
(60) Provisional application No. 63/688,004, filed on Aug. 28, 2024.

(51) Int. Cl. A01B 15/16

(52) U.S. Cl. CPC A01B 15/16

(57) ABSTRACT

Disclosed herein are various implementations relating to agricultural tillage discs with a geometry that provides significant advantages over existing models. This improved geometry allows for high-speed tillage while maintaining surface edges more uniformly than would be anticipated in prior models. Additionally, a new edge design allows for an improved edge-durability while maintaining soil penetration.

### CROSS-REFERENCE TO RELATED APPLICATION(S)

This application claims the benefit under 35 U.S.C. § 119(e) to U.S. Provisional Application 63/688,004, filed Aug. 28, 2024, and entitled “DISC BLADE WITH V-NOTCH AND ASSOCIATED SYSTEMS AND METHODS,” which is hereby incorporated by reference in its entirety for all purposes.

### TECHNICAL FIELD

The disclosure relates to agricultural equipment generally, and agricultural tillage blades specifically.

### BACKGROUND

There is a need in the art for an agricultural tillage blade or disc that allows for high-speed operation while maintaining its geometry. As would be known to those in the art, notched blades, typically used for high-speed tilling, often have geometries that are prone to uneven wear across their notches.

### BRIEF SUMMARY OF THE INVENTION

This disclosure relates to an agricultural tillage blade with a unique geometry that prevents uneven wear under high-speed operation.

Example 1 relates to an agricultural tillage disc comprising: a body comprising a center and an outer periphery surrounding the center; and a plurality of V-notches defined in the outer periphery, each V-notch comprising a first wall and a second wall disposed at an angle to one another about a vertex.

Example 2 relates to the Examples 1 and 3-15, further comprising a mount.

Example 3 relates to the Examples 1-2 and 4-15, wherein a plurality of openings are defined in the mount.

Example 4 relates to the Examples 1-3 and 5-15, wherein the mount comprises four openings defined therein.

Example 5 relates to the Examples 1-4 and 6-15, further comprising a bevel in the outer periphery.

Example 6 relates to the Examples 1-5 and 7-15, further comprising a compound bevel in the outer periphery, the compound bevel comprising a first bevel and a second bevel, wherein the second bevel is further from the center of the agricultural tillage disc.

Example 7 relates to the Examples 1-6 and 8-15, wherein the second bevel is at a steeper angle relative to the agricultural tillage disc compared to the first bevel.

Example 8 relates to the Examples 1-7 and 9-15, wherein the agricultural tillage disc is between about 20 inches and about 42 inches in diameter.

Example 9 relates to the Examples 1-8 and 10-15, wherein the agricultural tillage disc is between about 0.180 inches to 0.5 inches in thickness.

Example 10 relates to the Examples 1-9 and 11-15, wherein the angle is between about 38°and about 42°.

Example 11 relates to the Examples 1-10 and 12-15, wherein the angle is about 40°.

Example 12 relates to the Examples 1-11 and 13-15, wherein there are 10 or fewer V-notches.

Example 13 relates to the Examples 1-12 and 14-15, wherein there are 10 or more V-notches.

Example 14 relates to the Examples 1-13 and 15, wherein the V-notches are disposed so as to be evenly spaced around the outer periphery.

Example 15 relates to the Examples 1-14, wherein there is a transition between the first wall and second wall to prevent accumulation.

Example 16 relates to an agricultural tillage disc comprising: an outer periphery; a compound bevel in the outer periphery, the compound bevel comprising a first bevel and a second bevel, wherein the first bevel and second bevel are at different angles with respect to the agricultural tillage disc.

Example 17 relates to the Examples 16 and 18-19, wherein the agricultural tillage disc is between about 20 inches and about 42 inches in diameter.

Example 18 relates to the Examples 16-17 and 19, wherein the agricultural tillage disc is between about 0.180 inches to 0.5 inches in thickness.

Example 19 relates to the Examples 16-18, wherein the agricultural tillage disc is concave on one side and convex on the other.

Example 20 relates to an agricultural tillage disc comprising: a center; an outer periphery surrounding the center; a plurality of V-notches in the outer periphery, each V-notch comprising two straight walls at an angle to one another wherein the angle is about 40°, and wherein there are 10 V-notches.

### BRIEF DESCRIPTION OF DRAWINGS

FIG. 1 is a side view of an agricultural tillage disc, according to one implementation.

FIG. 2A is a diagram of a side view of an agricultural tillage disc, according to one implementation.

FIG. 2B is a diagram of an edge view of an agricultural tillage disc, according to one implementation.

FIG. 3 is a close-up view of the outer periphery of an agricultural tillage disc, according to one implementation.

FIG. 4 is a view of the double bevel in the outer periphery of an agricultural disc, according to one implementation.

FIG. 5 is a view of the concave side of an agricultural tillage disc, according to one implementation.

FIG. 6 is a view of the convex side of an agricultural tillage disc, according to one implementation.

### DETAILED DESCRIPTION

In the following detailed description of the implementations, reference is made to the accompanying drawings which form a part hereof, and in which is shown by way of illustration specific preferred implementations in which the disclosure may be practiced. These implementations are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description and are not intended to be used as limitations. Accordingly, orientation of an object or a combination of objects may change without departing from the scope of the disclosure.

Disclosed herein are various implementations relating to an improved system and devices for agricultural tillage.

### Agricultural Blade

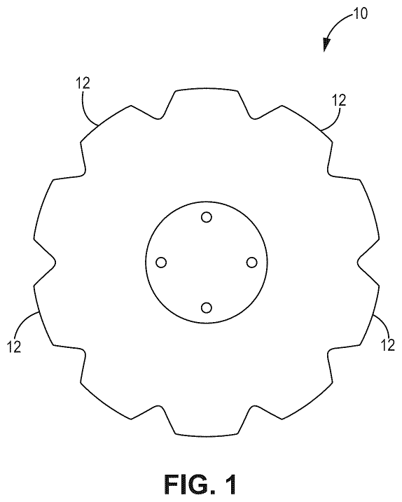

An agricultural blade 10 is shown in FIG. 1. In various implementations such as this, the agricultural blade 10 may also be referred to as a disc 10 or agricultural disc 10. Depending on the specific use case or end use. the blades 10 according to various implementations may be sized, that is be of any appropriate or suitable diameter and/or thickness and may be constructed out of any suitable material, as would be readily appreciated by those of skill in the art. For example, in some implementations, the blade 10 is of a diameter that is preferably about 20 inches to about 42 inches. In further implementations, the blade 10 is preferably about 0.180 inches to about 0.5 inches in thickness. However, the agricultural blade may be of any diameter and thickness without departing from the scope of the disclosure. In a still further implementation, the blade 10 is constructed out of a durable, hard material, including, but not limited to, metal, steel, alloys, hard plastics, and the like. In any case, each blade 10 comprises an outer periphery 12 configured to engage with the earth or soil, as would be understood.

In some implementations, the agricultural blade 10 may be dished. As would be understood, being dished involves being convex in shape on one side of the blade 10, while being concave on the opposite side of the blade 10.

### V-Notch

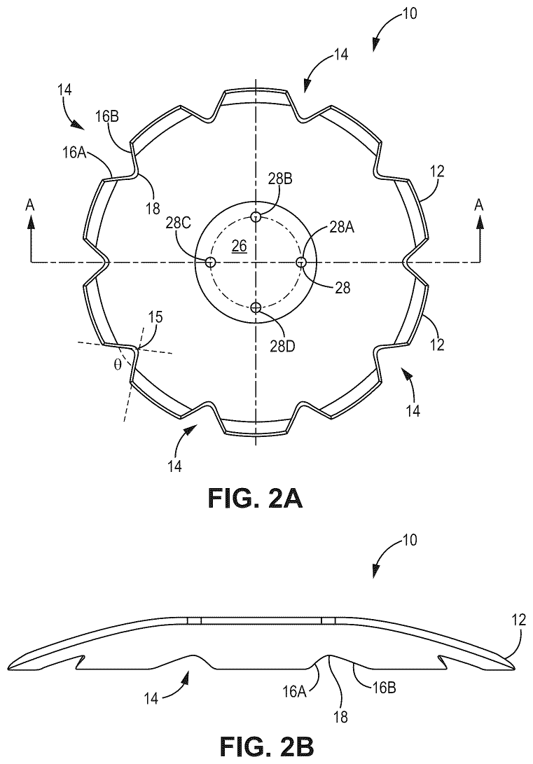

Turning now to FIGS. 2A and 2B, in some implementations, the agricultural blade 10 comprises one or more V-notches 14 disposed about the outer periphery 12. In various implementations, the V-notches 14 may be defined in sections of the outer periphery 12 that are indented toward the center 26, discussed in more detail below, of the blade 10. In some implementations, the V-notches 14 have a first wall 16A and second wall 16B joined by a transition 18. In various implementations, the walls 16A, 16B are substantially straight or linear (i.e. not curved) and may be disposed at an angle θ relative to one another, as shown in FIG. 2A. In some implementations, the angle θ may be about 40°. In further implementations, the walls 16A, 16B may be at an angle θ to one other in the range of about 38°to about 42°. Of course, other angles θ are possible, as would be understood.

In various implementations, the transition 18 is between the walls 16A, 16B and is a rounded connection point between the two walls 16A, 16B. That is, the transition 18 may be rounded or otherwise configured to span the vertex 15 of the notch 14 between the first wall 16A and second wall 16B and prevent the accumulation of soil, dirt, earth vegetable matter and the like.

In some exemplary implementations, there may be as many as ten V-notches 14 or more defined in the outer periphery 12. In other implementations, there may be fewer V-notches 14, such as 1, 2, 3, 4, 5, 6, 7, 8, or 9. In other implementations, there may be more than ten V-notches 14. In certain implementations, the V-notches 14 may be disposed evenly spaced around the outer periphery 12. The V-notches 14 are configured to provide an improved ability for the agricultural blade 10 to operate at high discing speeds while maintaining a defined profile. As would be understood, disc blades with traditional notch profiles, such as U-shaped notches can wear unevenly, which disforms their profile and reduces efficiency, effectiveness, and product life. The disclosed V-notches 14 resolve this issue of uneven wear of the notch profile while still allowing for high-speed discing. As would be understood, the presence of notches in the outer periphery 12 of an agricultural blade 10 also improves the turning ability of the equipment using the agricultural blades 10.

### Bevels

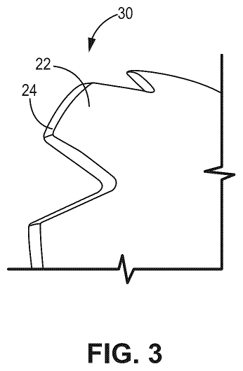

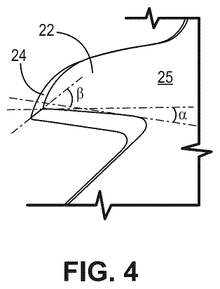

FIGS. 3 and 4 show the edge of the convex side of an agricultural blade 10, according to some implementations. As can be seen, in some implementations, the outer periphery 12 of the blade 10 has a compound bevel 20, which consists of a first bevel 22 and second bevel 24. In some implementations, the first bevel 22 is at a first angle α relative to the main body 25 of the blade 10, and the second bevel 24 is at second angle β relative to the main body 25 of the blade 10 than the first bevel 22. In some implementations, the first angle α is greater than the second angle β. In other implementations, the first angle α is less than the second angle β. In some implementations, the first angle α and second angle β are about equal.

In other implementations, the blade 10 may have only a first bevel 22, which may be of any angle desired for the particular implementation.

As would be understood, the implementations with only a first bevel 22 may present a narrower profile when penetrating the soil, thus reducing the force and energy required to drive the blade 10 into the soil during tillage. Alternatively, the implementations with a compound bevel 20 provide a reduced profile, although less than the first bevel 22 alone, but gains the advantage of a more robust edge that is more resistant to damage.

### Mounting System

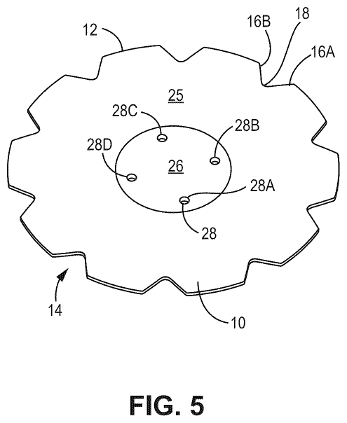

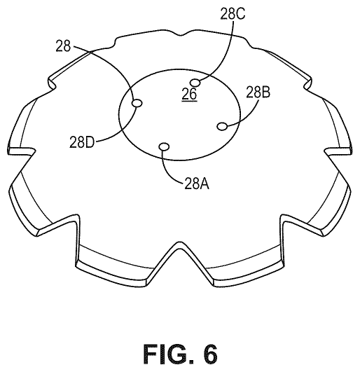

Shown in FIGS. 5 and 6, as well as in FIG. 2A, the agricultural blade 10 may have center 26, which may also be a mount 26. In some implementations, the mount 26 may be a flat portion of the blade 10. In various implementations, the mount 26 can comprise a plurality of openings 28A, 28B, 28C, 28D defined in the body 25 of the blade 10, optionally disposed or otherwise distributed evenly around the center 26 of the blade 10, such as at about 90° angles from one another. In some implementations, the mount 26 may have four openings 28. In other implementations, the mount 26 may have fewer openings 28, such as two or three. In still other implementations, the mount 26 may have more than four openings 28. As would be understood, these openings 28 may allow for the blade 10 to be mounted to a hub (not shown) on a piece of equipment so that the blade 10 may rotate freely while cutting through soil.

In other implementations, the mount 26 may have a single opening 28 in the center of the blade 10 so that the blade 10 is capable of being mounted on a single shaft on which it may rotate. In some implementations, the opening 28 may be a single opening 28 and may also be shaped to disallow rotation so that the shaft on which the blade 10 is mounted. In such implementations, it would be understood that the shaft would rotate, optionally on a bearing or other equipment capable of allowing rotation. Also in such implementations, the opening 28 may have a variety of shapes that complement the shaft's geometry and disallow rotation, such as but not limited to square, triangular, rectangular, cruciform, star-shaped, and the like.

Although the disclosure has been described with reference to preferred implementations, persons skilled in the art will recognize that changes may be made in form and detail without departing from the spirit and scope of the disclosed apparatus, systems and methods.

What is claimed is:

1. An agricultural tillage disc comprising:
(a) a body comprising a center and an outer periphery surrounding the center; and
(b) a plurality of V-notches defined in the outer periphery, each V-notch comprising a first wall and a second wall disposed at an angle to one another about a vertex.

2. The agricultural tillage disc of claim 1, further comprising a mount.

3. The agricultural tillage disc of claim 2, wherein a plurality of openings are defined in the mount.

4. The agricultural tillage disc of claim 3, wherein the mount comprises four openings defined therein.

5. The agricultural tillage disc of claim 1, further comprising a bevel in the outer periphery.

6. The agricultural tillage disc of claim 1, further comprising a compound bevel in the outer periphery, the compound bevel comprising a first bevel and a second bevel, wherein the second bevel is further from the center of the agricultural tillage disc.

7. The agricultural tillage disc of claim 6, wherein the second bevel is at a steeper angle relative to the agricultural tillage disc compared to the first bevel.

8. The agricultural tillage disc of claim 1, wherein the agricultural tillage disc is between about 20 inches and about 42 inches in diameter.

9. The agricultural tillage disc of claim 1, wherein the agricultural tillage disc is between about 0.180 inches to 0.5 inches in thickness.

10. The agricultural tillage disc of claim 1, wherein the angle is between about 38° and about 42°.

11. The agricultural tillage disc of claim 10, wherein the angle is about 40°.

12. The agricultural tillage disc of claim 1, wherein there are 10 or fewer V-notches.

13. The agricultural tillage disc of claim 1, wherein there are 10 or more V-notches.

14. The agricultural tillage disc of claim 1, wherein the V-notches are disposed so as to be evenly spaced around the outer periphery.

15. The agricultural tillage disc of claim 11, wherein there is a transition between the first wall and second wall to prevent accumulation.

16. An agricultural tillage disc comprising:
(a) an outer periphery;
(b) a compound bevel in the outer periphery, the compound bevel comprising a first bevel and a second bevel, wherein the first bevel and second bevel are at different angles with respect to the agricultural tillage disc.

17. The agricultural tillage disc of claim 16, wherein the agricultural tillage disc is between about 20 inches and about 42 inches in diameter.

18. The agricultural tillage disc of claim 16, wherein the agricultural tillage disc is between about 0.180 inches to 0.5 inches in thickness.

19. The agricultural tillage disc of claim 16, wherein the agricultural tillage disc is concave on one side and convex on the other.

20. An agricultural tillage disc comprising:
(a) a center;
(b) an outer periphery surrounding the center;
(c) a plurality of V-notches in the outer periphery, each V-notch comprising two straight walls at an angle to one another,
wherein the angle is about 40°, and
wherein there are 10 V-notches.
